(19) United States
(12) Patent Application Publication
(10) Pub. No.: US 2012/0152175 A1
(43) Pub. Date: Jun. 21, 2012

(54) Pee spot

(76) Inventor: Jing Li, Flushing, NY (US)

(21) Appl. No.: 12/928,801

(22) Filed: Dec. 20, 2010

(51) Int. Cl. A01K 29/00

(52) U.S. Cl. 119/161

(57) ABSTRACT

Training pad for housebreaking young dogs consisting of absorbent material imprinted with a circle which is impregnated with scented blue ink, contains SAP in the center, and backed by water impervious polyethylene which attracts young dogs to urinate only in the circle part of the pad.

### CROSS REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION BY REFERENCE OF MATERIAL SUBMITTED ON A COMPACT DISC

Not Applicable

### BACKGROUND OF THE INVENTION

### Prior Art

Dog owners of young dogs or puppies must train their dogs to urinate in a place where it does not soil anything in the house or wet the floor. This is a process which is known as “housebreaking” the dog. The traditional method of this type of training involves the dog urinating on newspaper, which is taught through using rewards and punishment. The disadvantage of this method is that the urine often runs off the paper because the dog does not always urinate in the middle of the paper or the paper becomes so soaked that it seeps out on to the floor.

Spellman, U.S. Pat. No. 3,626,899, utilizes a layered pad made of absorbent material which contains a lining which is impervious to fluid on one side, and which is impregnated with a substance which attracts young dogs. The problem with this method, which is now in wide use, is that the whole pad is scented, which results in some puppies urinating on the edge of the pad, and some of the urination is outside the pad.

It is the principal object of this invention to provide a training pad for young dogs which will attract the puppies to urinate in the middle of the pad instead of everywhere on the pad.

It is a further object of this invention to provide a training pad which is impregnated with a substance which elicits a scent only in the center of the pad and which attracts the young dog to urinate only in the part of the pad where the scent is emanating from to avoid the puppy urinating on part of the floor.

It is also an object of this invention to provide a pad which absorbs the fluid through the middle layer, which contains SAP, and which will turn the liquid into gel so that it will not leak through the pad and which will also eliminate the smell.

### SUMMARY OF THE INVENTION

The present invention is a method of housebreaking young dogs through use of a training pad containing four layers, the middle one containing SAP, a super absorbent polymer which turns liquid into gel. The top layer is imprinted with a circle which is scented with a black ink substance which will attract puppies to urinate on that circle only.

### DETAILED DESCRIPTION OF THE INVENTION

### Field of Invention

This invention relates to a method of housebreaking young dogs or puppies by use of a training pad with a specific scented area in the pad's center.

As used herein, young dogs or puppies include dogs from the time they are weaned until they reach 10 to 12 months of age. Housebreaking refers to the training of young dogs to refrain from urinating or defecating in its owner's residence.

### BRIEF DESCRIPTION OF THE DRAWINGS

FIG. 1 is a top view plan of The Pee Spot pad

FIG. 2 is a bottom view of the Pee Spot Pad

FIG. 3 is a perspective view of a dog's interaction with the Pee Spot pad

FIG. 4 is a fragmented sectional view of the layers of The Pee Spot pad before the absorption of the liquid

FIG. 5 is a fragmented sectional view of the layers of the Pee Spot pad after the absorption of the liquid

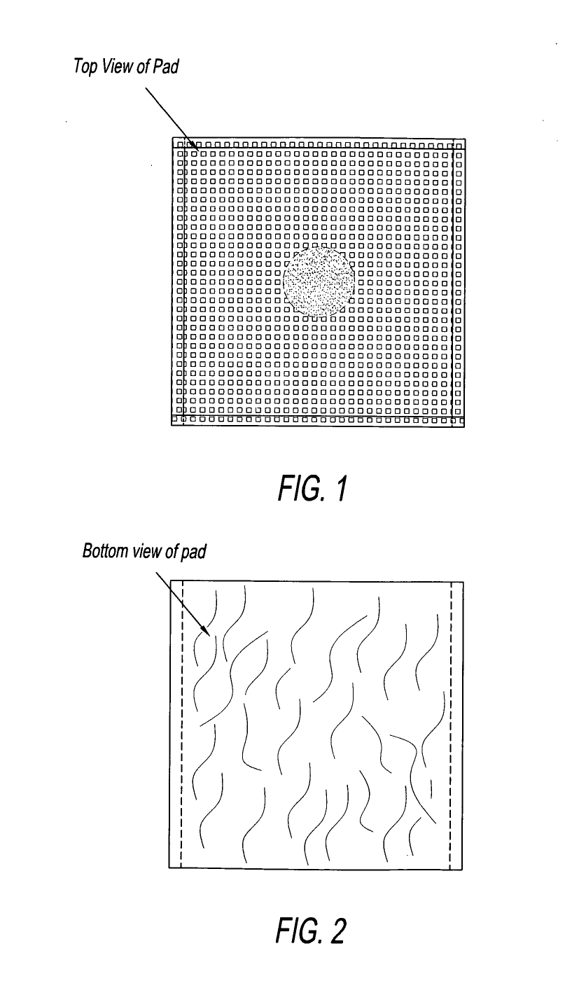

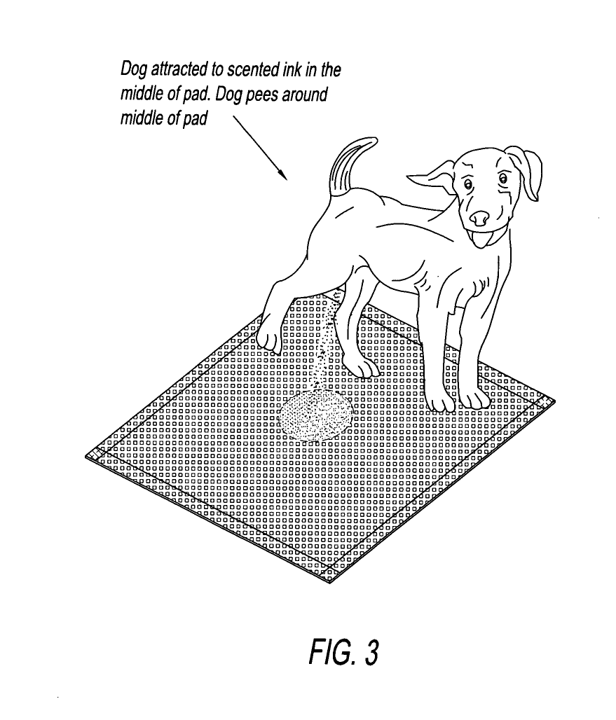

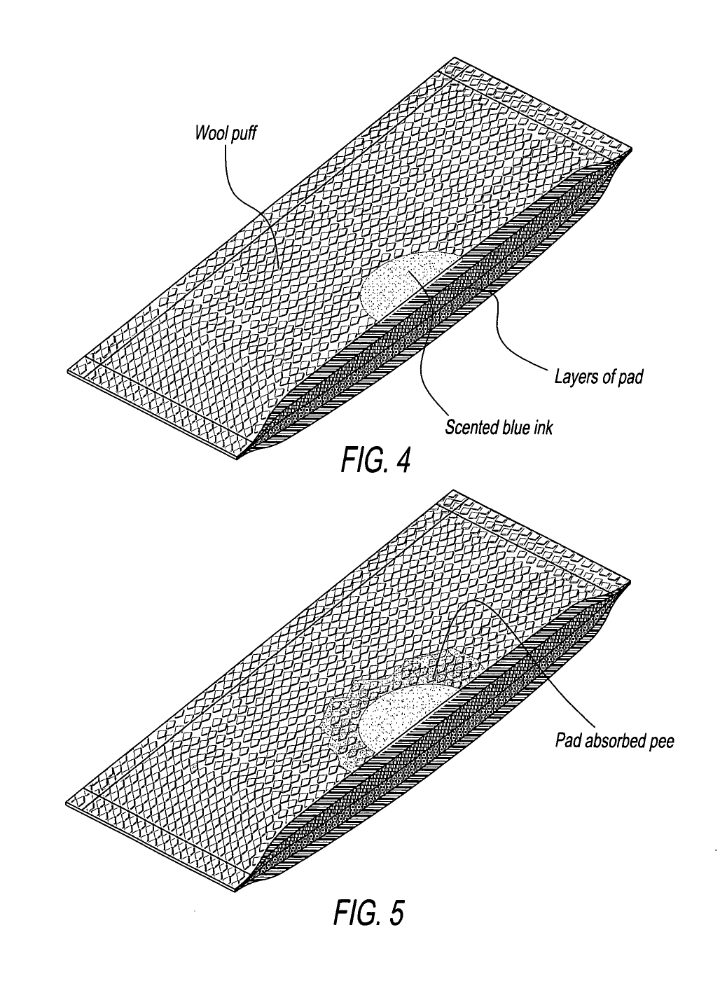

As indicated above, the pad which is this invention comprises the several layers shown in the drawings.

Layer 1 is a non-woven scratch free material made of wool puffs, which is highly absorbent and with the circle spot imprinted on the center surface

Layer 2 is absorbent tissue paper which is glued to the material

Layer 3 is SAP (Super absorbent polymer) plus absorbent wood chips

Layer 4 is absorbent tissue which is glued to the absorbent material

Layer 5 is water impervious polyethylene

All five layers are then embossed together by any suitable means known to the art. There is approximately 2-3 grams of SAP in the pad and the whole pad is approximately 35-40 grams. 2 grams of SAP can absorb about 35 ounces of liquid.

It is obvious that the training pads of the invention are well suited for their intended purpose. The fluid impervious backing prevents transfer of fluid, if any, to the underlying floor area, thereby preventing damage from discoloration, staining, and other damage to floors and carpets. Moreover, the SAP should prevent the urine to remain in liquid form, which will also prevent any leakage and resulting damage

What is claimed is:

1. A training pad for young dogs comprising 5 layers, the top layer of which is an absorbent scratch free material made of wool puffs imprinted with a circle which is scented with a blue ink substance which will attract young dogs to urinate only on that circle.

2. A method of housebreaking young which consists of placing in a location a training pad of absorbent material which is attached to a layer of SAP which will turn the liquid into gel so that it will not leak through the pad and will eliminate the urine smell and backed by a layer of water impervious polyethylene.
